(19) United States
(12) Patent Application Publication
(10) Pub. No.: US 2020/0270553 A1
(43) Pub. Date: Aug. 27, 2020

(54) METHOD OF MAKING AN INDIVIDUALIZED ALCOHOLIC BEVERAGE

(71) Applicant: BRAIN BREW VENTURES 3.0, INC., Newtown, OH (US)

(72) Inventors: Douglas B. HALL, Newtown, OH (US); Joseph M. GIRGASH, Newtown, OH (US)

(73) Assignee: BRAIN BREW VENTURES 3.0, INC., Newtown, OH (US)

(21) Appl. No.: 16/650,152

(22) PCT Filed: Sep. 25, 2018
(86) PCT No.: PCT/US18/52615

§ 371 Date: Mar. 24, 2020

Related U.S. Application Data
(60) Provisional application No. 62/562,667, filed on Sep. 25, 2017.

(51) Int. Cl. C12G 3/07; C12C 11/11

(52) U.S. Cl. CPC C12G 3/07; C12C 11/11

(57) ABSTRACT

The present invention is an alcoholic beverage having the sensory characteristics of a traditionally aged distilled spirit based on the individualized palate preferences of an individual. The method includes having an individual taste multiple standardized distilled spirits, mixing the standardized distilled spirits until a desired sensory experience is met, and then scaling up production of the same desired sensory experience for that particular individual.

### CROSS-REFERENCE TO RELATED APPLICATION

The present application claim priority to provisional U.S. Patent Application No. 62/562,667 as filed Sep. 25, 2017.

### STATEMENT REGARDING FEDERALLY SPONSORED RESEARCH

Not applicable.

### NAMES OF THE PARTIES TO A JOINT RESEARCH AGREEMENT

Not applicable.

### INCORPORATION-BY-REFERENCE OF MATERIAL SUBMITTED ON A COMPACT DISC

### Not applicable.

### BACKGROUND OF THE INVENTION

### 1. Field of the Invention

The present invention relates generally to alcoholic beverages, and more specifically relates to a method, and resulting spirits, for creating an individualized alcoholic spirit that imparts the sensory characteristics of a matured distilled spirit with variables controlled by a consumer.

### 2. Description of the Related Art

In traditional whiskey-making methods, a high proof distillate is aged in an oak barrel and the wood adds color, smoothness, flavor, and other characteristics to the whiskey.

There are numerous known ways of making a distilled spirit; some large scale, some small scale. However, typically in making such a distilled spirit, it is a “one-size fits all.” That is, a particular recipe is followed in order to achieve as similar of a flavor, texture, and experience no matter what individual bottle of the distilled spirit from that particular manufacturer is consumed. Often times these one-size fits all spirits are considered to possess single tasting characteristics where there may be a pronounced single flavor, aroma, etc. and may be deemed to be “simple” in that it is one pronounced taste that comes and goes similar and is analogous to playing a single note on a piano. However, the more complex, multi-note, spirits often are hard for novices to taste and know what they like because there are so many flavors, textures, and aromas interacting and building upon one another.

Traditionally, such a process of making a singular experience per distilled spirit seemed to please most consumers. And most consumers would gravitate to a particular brand, grain, or region and thereby compromise, if you will, to what the variables of the distilled spirit are offered by the seller.

Consumers, generally speaking, have shown a desire to be more educated in what they consume. This includes developing and appreciating their own palate; and by using the Internet, finding new flavors and taste experiences that they could not have easily found previously. And consumers have spoken with their wallets for wanting products and services that are more individualized than mass created.

Traditional means of making barrel-aged distilled spirits could take anywhere from 3 to 50 years to make. However, as described in U.S. patent application Ser. No. 15/768,614, incorporated by reference, a process for rapidly imparting the sensory characteristics of a matured distilled spirit to a younger distilled spirit is set forth. This process allows the process of creating a mature tasting distilled spirit in as quickly as 40 minutes.

Such process allows the sensory characteristics that are developed through multiple years of aging with a wood barrel, however, in a significantly shorter period of time so to reduce product cost and create opportunities for crafting new taste experiences not possible through classic barrel aging.

Thus, what is desired is a method for providing the sensory impression of a matured distilled spirit based upon the individualized palate of a consumer, but at a total process time of less than a day and at lower applied pressures and at a smaller scale than an entire barrel.

### SUMMARY

The present invention is an alcoholic beverage having the sensory characteristics of a traditionally aged distilled spirit based on the individualized palate preferences of an individual. The method includes having an individual taste multiple standardized distilled spirits, mixing the standardized distilled spirits until a desired sensory experience is met, and then scaling up production of the same desired sensory experience for that particular individual.

### DRAWINGS

FIG. 1 is a flowchart showing a method for developing a rapidly aged spirit based upon an individual's preference.

FIG. 2 is an exemplary matrix of distilled spirits for an individual to use to develop their own spirit.

### DESCRIPTION

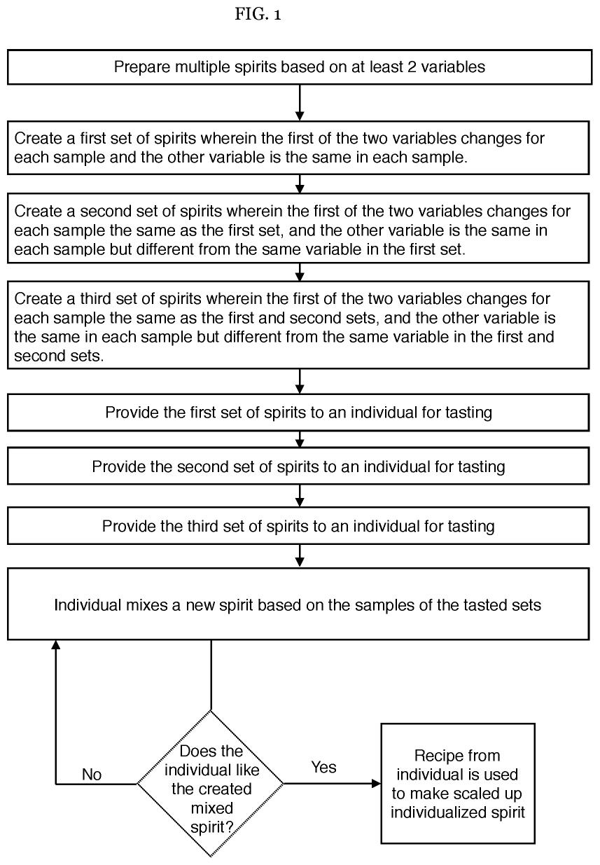

Referring to the FIG. 1, the present invention includes a method for imparting the sensory characteristics of a traditionally aged distilled spirit to a younger distilled spirit in a significantly shorter time period based upon the distilled spirit characteristics chosen by an individual.

In particular, the present method allows the sensory characteristics in flavor, texture, color, smoothness, and ease of drinking in a distilled spirit to be customized based upon an individual's preferences. And beyond distilled spirits, the present invention can be used to make other individualized beverages, alcoholic or non-alcoholic.

The method begins by first picking at least two variables that can be altered in a particular distilled spirit. Three or more variables can also be varied using the present method, though the complexity does increase. For the sake of simplicity of explaining the present method, the description will focus on just two variables at a time.

The interchangeable terms “distilled spirit” or “spirit,” used throughout, refer to a distilled beverage that has at least 5% alcohol by volume (ABV). The spirit herein can be a young or aged spirit, where an aged spirit needs to be in wood for at least three years according to some countries regulations, and a young spirit is defined as a new make spirit. The present method allows further processing and/or finishing of such young or aged spirit.

The spirit may be any of whiskey, scotch whisky, bourbon, vodka, gin, rum, brandy, eau de vie (fruit brandy or schnapps), tequila, baijiu, soju, aguardiente, pálinka, cachaça, singani, borovička, slivovitz, moonshine, raw or young spirit, or a combination thereof.

The example herein will be an individualized whiskey. The variables of the example will include types of grain and types of wood chips.

There are four types of grains that could be used for this example and are in the form of corn-based, wheat-based, rye-based, and barley-based spirts.

It is preferred in this example that a spirit using just one of the four grains each be used. Young or aged spirits can be used, as long as it is properly recorded what is used. And blends can also be used.

The spirit is introduced to a container and wood chips, as a second variable are introduced to the spirit in the container.

The wood chips may be from previously-used casks. However, the wood chips may also come from other sources so long as the wood is prepared as is generally known in the industry. In an exemplary embodiment, the wood chips have primary side (length×width) dimensions of about 1 to about 2 inches in length, about ½ to about 1 inch in width, and a thickness of about ⅛ to about ¼ inch. Although the wood chips are discussed as being substantially rectangular in shape, it is understood by those of ordinary skill in the art that the wood chips will vary in shape and size and may not be uniform in dimensions. The preferred amount of wood chips is at a ratio of about 10 to about 120 grams of wood chips per 750 mL of the raw distilled spirit.

The wood chips can vary based on type of wood, region, age, preparation of the wood chips, charring of the wood chips, flavoring of the wood chips, etc. A variable for the wood chips is chosen for an individual to taste. For the present example, new American oak barrel chips are used in the first and second sets and are varied based on age of the wood.

The container holding the mixture of wood chips and spirits is sealed and heated until the measured pressure of the inside of the sealed container increased to a minimum of 5 psi and not to be greater than about 50 psi. It is critical that the pressure not exceed 50 psi as non-desirable sensory characteristics of the wood chips may be drawn out into the resulting spirit. The container is then removed from the heat and allowed to cool to substantially room temperature and the pressure within the inside of the container is reduced to a predetermined low pressure. The resulting spirit is then filtered to remove the wood chips and and other substantially non-liquid components.

Other variables that can controlled include, for example, alcohol grain, alcohol type, wood type, wood age, wood preparation, wood chip flavoring, cycles of aging, and alcohol percentage (proof).

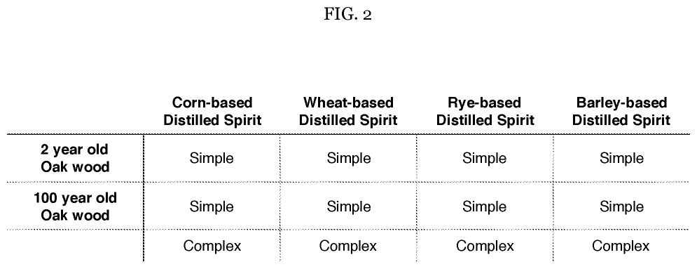

As illustrated in the example set forth in FIG. 2, a matrix may be created relative to grain type and wood chips as the two variables. And a spirit with those variables is created for each. So, in the example illustrated in FIG. 2, 12 different spirits are created.

An individual is then presented with a first set of standardized spirits to taste. In this example, the first set would be in the form of four different grain spirits but each created with wood chips from 2 year aged wood.

The individual then preferable tastes each of the first set of standardized spirits and takes notes on what is preferred or not preferred in each.

A second set of standardized spirits is then presented to the same individual. Like with the first set, there are four different grain spirits but instead of the wood used in the first set, a 100 year aged wood is used in the creation of the respective spirits.

Again, individual then preferable tastes each of the second set of standardized spirits and takes notes on what is preferred or not preferred in each.

It is key to note that whiskeys, in particular, may have varying simplistic to complex tastes, mouth feel/texture, nose, etc. It is typical that a lower-cost mass-market whiskey is less complex and has what may be referred to as “single note” in flavor or aroma, meaning that the individual tasting the whiskey has a very simple flavor that comes and goes and is analogous to playing a single note on a piano.

To those newer to whiskey, the simple single note changes within a set help the individual understand parts of the possible flavor combinations that s/he likes or dislikes without the distraction of other flavors/notes. So, in a preferred embodiment of the present invention, the first and second sets are simple whiskeys with a pronounced single flavor or other tasting characteristic.

The first set is preferably left with the individual who can then return to the first set to again taste any of the spirits relative to those of the second set.

In this example, there is a third wood used to create spirits, so a third set of standardized spirits is then presented to the some individual. Like with the first and second sets of spirits, the individual preferably tastes each spirit and notes what is preferred and not preferred in each. The third wood could be one spirit could be aged using a unique type of wood.

In a preferred embodiment, the third set is a more complex set of whiskey flavors and other tasting characteristics. As opposed to the simple whiskeys of the first set that were previously compared to playing a single note on a piano, these whiskeys would be more of an orchestra playing multiple notes at once. These flavors are more complex where various flavors and tasting characteristics strike the individual's senses at varying strengths, times, and places. The complex whiskeys, tasted after the simple whiskeys, helps an individual better understand how the characteristics of the whiskey come together in a way that the individual likes best. In a preferred embodiment, the third set of spirits is what would be considered by those in the industry as a complex whiskey profile where there is more than a single note of flavor, texture, or other tasting characteristics as in the simple whiskey profile.

Having the first and second sets being simple tastes and the third set being complex tastes is a critical choice when testing among a wide range of whiskey tasting confidence. The first two sets provide those with high whiskey confidence the ability to craft more from scratch as a whiskey maker would do. The third set provides a safe way for those with less “whiskey confidence” to take a well made product and modify it to their better taste.

It has been observed that the structured approach according to the present invention enables individuals the ability to create an individualized distilled spirit that has a high appeal. Evidence of this is a study of participants a week after where they gave a weighted purchase/uniqueness score of 8.9 out of 10. This score is the highest after use score ever realized in 25 years of whiskey product tasting where most products score in the 4 to 6 range.

A random set of whiskies for individuals to taste does not provide the structure needed for them to understand the whiskey characteristics that they like the most and how they interact with other whiskey characteristics.

After tasting each of spirits presented, the individual mixes the different spirits based on the individual's own preferences into another container.

The amount of each spirit mixed together may be different. For example, the individual may take 5 mL of the corn spirit from the first set and add 12 mL of the rye spirit from the second set.

The individual may mix as many of the spirits as desired in any ratio desired. It is preferred that the individual keep written record of what is being mixed together.

Once the spirits are mixed, the individual is encouraged to taste the resulting spirit to see if it meets with the individual's preferences. If it doesn't, the individual is encouraged to continue adding to the then-current mixture of spirits or to start over.

If the resulting spirit does meet with the individual's preferences, the individual provides the written record of the mixture, which is then converted into a scaled up recipe per bottle, case of spirits, or barrel, based on the amount of the spirit that the individual desires to have. A scaled up mixture or blend is then created for the individual based on the individual's recipe and the method of U.S. patent application Ser. No. 15/768,614, and then provided to the individual.

In a preferred embodiment, the recipe of each individual is saved for future creation of the same blend if desired by the individual. While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

What is claimed is:

1. A method of making an individualized alcoholic beverage, the steps including:
preparing multiple sets of spirits based on at least 2 variables, wherein the variables may be chosen from grain type, alcohol type, wood type, wood age, wood preparation, wood flavoring, cycles of compression, and alcohol percentage;
wherein a first set of spirits has at least a first variable that changes for each spirit of the set, and at least a second variable that remains substantially the same same for each spirit of the first set;
wherein a second set of spirts has at least a first variable that changes for each spirit of the set, and at least a second variable that remains substantially the same for each spirit of the second set but is different from each spirit of the first set;
wherein a third set of spirts has at least a first variable and at least a second variable combination that is different from any of the spirits in the first or second set;
providing the first set of spirits to an individual for tasting;
providing the second set of spirts to an individual for tasting;
providing the third set of spirits to an individual for tasting;
permitting the individual to mix a new spirits at the individual's discretion with the chosen from the spirits of the first set of spirits, second set of spirts, third set of spirits, or an combination thereof; and
creating one or more bottles of the new spirits mixed by the individual.

2. The method according to claim 1, wherein the first variable is each chosen from grain type in the form of corn-based, wheat-based, rye-based, and barley-based, respectively.

3. The method according to claim 1, wherein the first variable is chosen from grain type in the form of a blend of grain-based spirits.

4. The method according to claim 1, wherein the second variable is chosen from wood type.

5. The method according to claim 1, wherein the second variable is chosen from wood age.

6. The method according to claim 1, wherein the first variable of the first set and second set is each chosen from grain type in the form of corn-based, wheat-based, rye-based, and barley-based, respectively.

7. The method according to claim 6, wherein the first variable of the third set is chosen from grain type in the form of a blend of grain-based spirits.

8. The method according to claim 1, wherein the first variable is alcohol type.

9. The method according to claim 1, wherein each of the spirits of each set is created by
introducing a distilled spirit having an alcohol content of about 10% to about 57% to a container;
adding wood chips at a ratio of about 10 to about 120 grams per 750 mL of the raw distilled spirit to the container;
sealing the container; and
increasing an internal pressure of the container to about 5 psi to about 50 psi such that when a maximum predetermined pressure is achieved within the container, the pressure is then released and the internal pressure is reduced back to a predetermined lower pressure,
wherein the increasing step is performed one or more times.

10. A individualized distilled spirit created based on an individual's own preferences, produced by the steps of:
preparing multiple sets of spirits based on at least 2 variables, wherein the variables may be chosen from grain type, alcohol type, wood type, wood age, wood preparation, wood flavoring, cycles of compression, and alcohol percentage;
wherein a first set of spirits has at least a first variable that changes for each spirit of the set, and at least a second variable that remains substantially the same same for each spirit of the first set;
wherein a second set of spirts has at least a first variable that changes for each spirit of the set, and at least a second variable that remains substantially the same for each spirit of the second set but is different from each spirit of the first set;
wherein a third set of spirts has at least a first variable and at least a second variable combination that is different from any of the spirits in the first or second set.
providing the first set of spirits to an individual for tasting;
providing the second set of spirts to an individual for tasting;
providing the third set of spirits to an individual for tasting;
permitting the individual to mix a new spirits at the individual's discretion with the chosen from the spirits of the first set of spirits, second set of spirts, third set of spirits, or an combination thereof; and
creating one or more bottles of the new spirits mixed by the individual.

11. The individualized distilled spirit according to claim 10, wherein the first variable is each chosen from grain type in the form of corn-based, wheat-based, rye-based, and barley-based, respectively.

12. The individualized distilled spirit according to claim ii, wherein the first variable is chosen from grain type in the form of a blend of grain-based spirits.

13. The individualized distilled spirit according to claim 10, wherein the second variable is chosen from wood type.

14. The individualized distilled spirit according to claim 10, wherein the second variable is chosen from wood age.

15. The individualized distilled spirit according to claim 10, wherein the first variable of the first set and second set is each chosen from grain type in the form of corn-based, wheat-based, rye-based, and barley-based, respectively.

16. The individualized distilled spirit according to claim 15, wherein the first variable of the third set is chosen from grain type in the form of a blend of grain-based spirits.

17. The individualized distilled spirit according to claim 10, wherein the first variable is alcohol type.

18. The individualized distilled spirit according to claim 10, wherein each of the spirits of each set is created by
introducing a distilled spirit having an alcohol content of about 10% to about 57% to a container;
adding wood chips at a ratio of about 10 to about 120 grams per 750 mL of the raw distilled spirit to the container;
sealing the container; and
increasing an internal pressure of the container to about 5 psi to about 50 psi such that when a maximum predetermined pressure is achieved within the container, the pressure is then released and the internal pressure is reduced back to a predetermined lower pressure, wherein the increasing step is performed one or more times.

19. A method of making an individualized alcoholic beverage, the steps including:
preparing multiple sets of spirits based on at multiple variables, wherein the variables may be chosen from grain type, alcohol type, wood type, wood age, wood preparation, wood flavoring, cycles of compression, and alcohol percentage;
wherein a first set of spirits and a second set of spirits is created to have a simple tasting profile that provides a pronounced single tasting characteristic such as flavor, texture, aroma, and the like;
wherein a third set of spirts is created to have a complex tasting profile that provides a multiple and varying pronounced tasting characteristic such as flavor, texture, aroma, and the like;
providing the first set of spirits to an individual for tasting;
providing the second set of spirts to an individual for tasting;
providing the third set of spirits to an individual for tasting;
permitting the individual to mix a new spirits at the individual's discretion with the chosen from the spirits of the first set of spirits, second set of spirts, third set of spirits, or an combination thereof; and
creating one or more bottles of the new spirits mixed by the individual.
